(19) United States
(12) Patent Application Publication
(10) Pub. No.: US 2008/0035185 A1
(43) Pub. Date: Feb. 14, 2008

(54) Apparatus for cleaning paint rollers

(76) Inventor: Joseph P. Baratta, Boca Raton, FL (US)

Correspondence Address: LERNER GREENBERG STEMER LLP, P O BOX 2480, HOLLYWOOD, FL, 33022-2480, US

(21) Appl. No.: 11/503,329

(22) Filed: Aug. 11, 2006

(51) Int. Cl. B08B 3/00

(52) U.S. Cl. 134/137; 134/198

(57) ABSTRACT

An apparatus for cleaning a paint roller includes a container having a top with an insertion opening for introducing a paint-carrying surface of the paint roller into the container and a bottom with a discharge opening for discharging paint out of the container. A spray pipe has holes formed therein for directing water toward the paint-carrying surface within the container. The spray pipe rotates and the paint roller is movable vertically, for washing paint off substantially all of the paint-carrying surface and out of the discharge opening.

### BACKGROUND OF THE INVENTION

1. Field of the Invention

The invention relates to an apparatus for cleaning paint rollers.

2. Description of the Related Art

Paint rollers are commonly used for painting large surfaces quickly, as opposed to brushes which are used for more careful and slower painting. Paint rollers have a paint-carrying surface which absorbs paint, such as from a tray. When painting is finished for the day, the paint-carrying surface of the roller must cleaned or else the paint will dry on the paint-carrying surface rendering it useless for further painting. Professional painters use expensive rollers which are only cost-effective if cleaned after each use.

Paint rollers are conventionally cleaned by spraying water from a garden hose at the roller. Such a procedure is not only haphazard and therefore inadequate to clean every part of the paint-carrying surface, but it allows the paint to spray in every direction and cause a messy and environmentally hazardous situation.

U.S. Pat. No. 4,126,484 discloses a paint roller cleaner in which a sleeve containing a paint-carrying surface of a paint roller is placed in a container and liquid under pressure is forced through the container. The sleeve must be removed from the roller which is very messy and results in paint dripping, and liquid only impinges on the sleeve from one end which results in inadequate cleaning. A similar device with similar disadvantages in disclosed in U.S. Pat. No. Des. 340,327.

U.S. Pat. No. 5,935,342 teaches a paint roller cleaner in which a paint roller sleeve is placed in a container and a nozzle traverses the sleeve. The device is very complicated and therefore expensive and the nozzle can only clean one portion of the sleeve at a time.

U.S. Pat. No. 5,238,012 includes a container in which a sleeve of a paint roller in disposed. A spray bar which is fixed in the container sprays water on the sleeve which is rotated by a motor. The need for a motor makes the device complicated and therefore expensive.

According to U.S. Pat. No. 5,487,399, a sleeve is placed in a housing on a support and water is sprayed on the sleeve from outside the housing. The need to remove the sleeve and the placement outside the housing make the device messy and complicated and therefore expensive. Similarly, according to U.S. Pat. No. 4,708,152, the sleeve must be removed from the paint roller and placed on a holder in a bucket, so that water can be sprayed onto the sleeve. The bottom of the bucket prevents paint from flowing out and the open top allows paint to spray out.

U.S. Pat. No. 4,446,590 discloses a paint roller cleaner in which a sleeve is pivoted in a housing and jets of a water-detergent solution are directed at the sleeve. A scrubbing member engages the sleeve as the liquid is being sprayed, which makes the device very complicated and therefore expensive. The fact that the housing is closed requires special measures for removing the paint therefrom.

U.S. Pat. No. 5,505,220 relates to a tangential spray paint roller cleaner in which a sleeve is placed in a container while still attached to the paint roller handle. Two spray bars direct water under pressure at the sleeve. An arm connected between the sleeve and the handle is placed in a vertical slot in the side wall of the container, necessitating a shield and an absorption membrane to prevent paint from spraying out of the side of the container. The membrane will absorb paint and require changing or cleaning. The container is closed on the bottom so that a complicated piping system is needed to remove the paint and a lid must be placed on the container to prevent paint from spraying out of the top of container. The lid and the combination of the shield and the membrane which maintain a seal around the shaft of the handle, prevent the sleeve from being moved vertically.

### SUMMARY OF THE INVENTION

It is accordingly an object of the invention to provide an apparatus for cleaning paint rollers, which overcomes the hereinafore-mentioned disadvantages of the heretofore-known devices and methods of this general type, which is simple to use, ensures that every part of the paint-carrying surface is cleaned, prevents paint from spraying in undesired directions without complicated seals and channels the paint being washed off the roller in a simple manner.

With the foregoing and other objects in view there is provided, in accordance with the invention, an apparatus for cleaning a paint roller. The apparatus comprises a container having a continuous side wall, a permanently-open upper insertion opening for introducing a paint-carrying surface of the paint roller into the container while attached to a handle of the paint roller disposed outside the container, and a permanently-open lower discharge opening for discharging paint out of the container. A device is provided for directing a fluid toward the paint-carrying surface within the container for washing paint off the paint-carrying surface and out of the discharge opening. These features provide an apparatus which thoroughly cleans the paint-carrying surface but prevents paint from scattering uncontrollably. The container has no cover above the paint-carrying surface nor any other elements restricting vertical movement of the paint roller, so that it can be moved vertically during washing.

In accordance with another feature of the invention, the container has a top in which the upper insertion opening is formed and a bottom in which the lower discharge opening is formed. In the simplest form of the apparatus, the discharge opening covers all or substantially all of the bottom of the container.

In accordance with a further feature of the invention, the device for directing the fluid toward the paint-carrying surface includes a spray pipe having nozzles for the fluid.

The spray pipe has a coupling for a garden hose and the fluid is water. The nozzles direct the water toward the paint-carrying surface. The nozzles may be holes formed in the spray pipe. In this preferred embodiment of the apparatus, a standard garden hose which is always available or can be readily made available, provides a simple way of introducing the fluid which carries out excellent cleaning of the paint roller.

In accordance with an added feature of the invention, the spray pipe is rotatable in the container for directing the water toward different locations on the paint-carrying surface. The device for directing the fluid toward the paint-carrying surface selectively rotates the paint-carrying surface in different directions by swinging the hose attached to the spray pipe in one direction and the other.

In accordance with an additional feature of the invention, legs raise the container and facilitate the discharge of the paint out of the container.

In accordance with still another feature of the invention, the spray pipe is movable vertically in the container over a distance being limited by a stop, such as a cap on the lower end of the spray pipe below the bottom.

In accordance with yet another feature of the invention, there is provided a device for holding the paint roller horizontally while permitting the paint roller to move vertically in the container. The holding device may be bars disposed on the top of the container. The legs of a U-shaped channel may serve as the bars.

In accordance with yet a further feature of the invention, the side wall has an outer surface disposed at a given distance from an edge of the insertion opening, and the outer surface has a flat vertical portion disposed at a distance from the edge of the insertion opening being less than the given distance. This facilitates placement of the paint-carrying surface within the container and a handle of the paint roller outside the container. The edge of the insertion opening has a flat portion parallel to the flat vertical portion and the container has a bottom with a flat portion parallel to the flat vertical portion. The arm or shaft of the roller, which connects the paint-carrying surface to the handle, can easily span this reduced distance with play for moving the roller.

With the objects of the invention in view, there is also provided an apparatus for cleaning a paint roller, comprising a container having a continuous or unbroken side wall with no openings, a top with an insertion opening for introducing a paint-carrying surface of the paint roller into the container and a bottom with a discharge opening for discharging paint out of the container. A spray pipe having holes formed therein directs water toward the paint-carrying surface within the container. The spray pipe is circumferentially rotatable and the paint roller is movable vertically, for washing paint off substantially all of the paint-carrying surface and out of the discharge opening. The combination of rotation of the spray pipe and thus spray jets and the vertical movement of the spray pipe carried out by two hands of the operator of the apparatus, thoroughly washes the paint-carrying surface. The continuous side wall prevents paint from splattering outside the container.

Other features which are considered as characteristic for the invention are set forth in the appended claims.

Although the invention is illustrated and described herein as embodied in an apparatus for cleaning paint rollers, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, longitudinal-sectional view of an apparatus according to the invention for cleaning paint rollers, which is taken along a sectional line shown in FIG. 2, and in which a paint roller is disposed;

FIG. 2 is a top-plan view of the apparatus according to FIG. 1, also including a paint roller;

FIG. 3 is a bottom plan view of the apparatus according to FIG. 1; and

FIG. 4 is a perspective view of a spray pipe of the apparatus according to FIG. 1.

### DESCRIPTION OF THE PREFERRED EMBODIMENTS

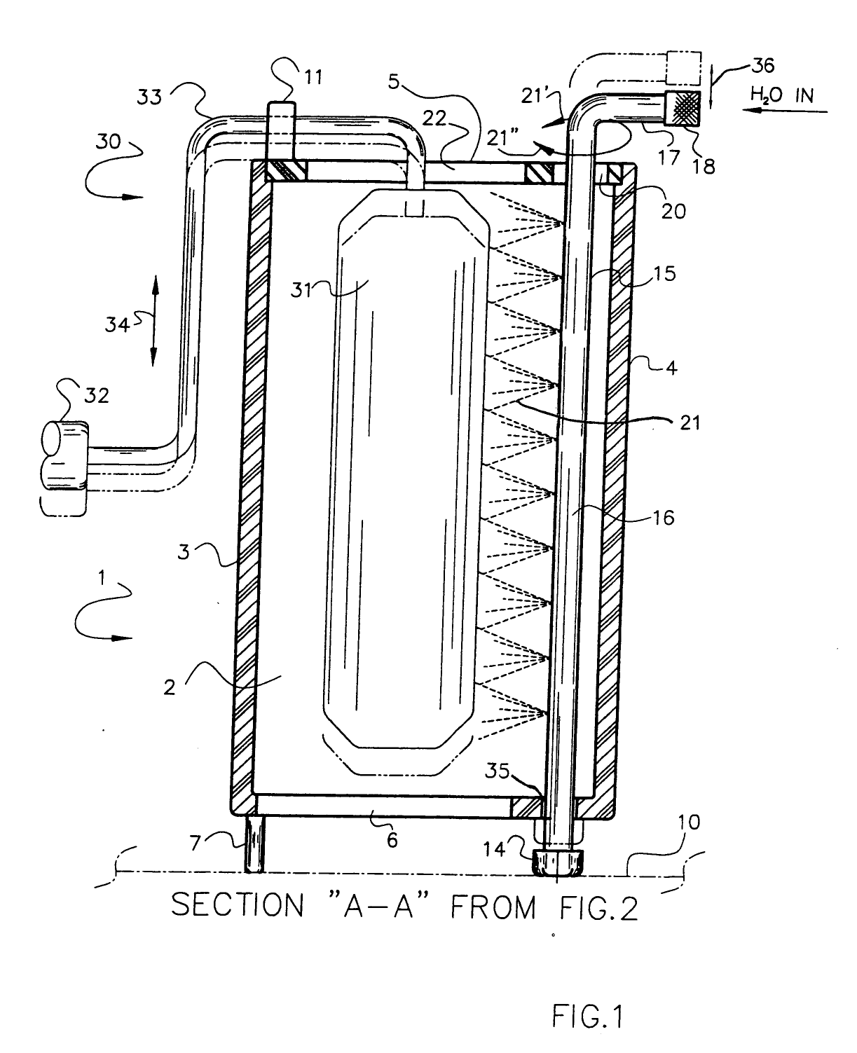

Referring now to the figures of the drawings in detail and first, particularly, to FIG. 1 thereof, there is seen an apparatus for cleaning paint rollers. The apparatus includes a substantially cylindrical container 1 having a continuous or unbroken side wall 4 with no openings therein, a top 5 and a bottom 6. The cylindrical container 1 may be formed of plastic or metal, for example, and have a diameter of approximately 8″ and a height of approximately 12″ for standard paint rollers. Three legs 7, 8, 9, which are approximately 1½″ high, are disposed under the bottom 6 for supporting the cylindrical container 1 on a surface 10, such as the bottom of a basin.

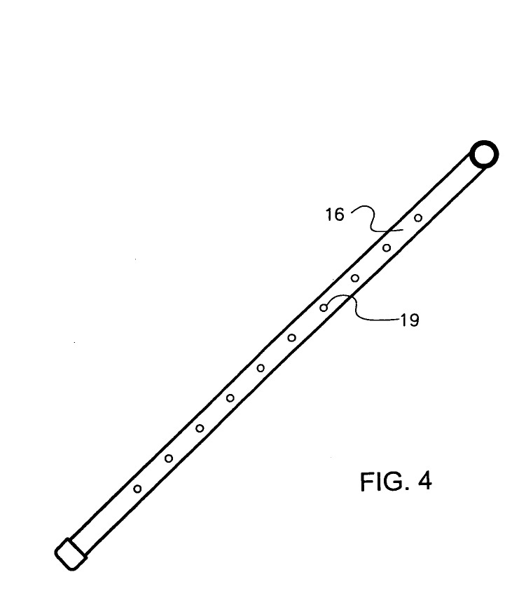

A device for conducting a fluid toward a paint-carrying surface of a paint roller is constructed as an L-shaped spray pipe 15 with a vertical leg 16 and a horizontal leg 17. A coupling 18 for a garden hose or a cleaning fluid delivery pipe is disposed at the end of the horizontal leg 17. Of course, the legs 16, 17 may be joined at an elbow. The spray pipe 15 may be formed of any sturdy material, although ½″ CPVC is preferred. The vertical leg 16 passes through a hole 20 that is approximately 1″ in diameter in the top 5 of the cylindrical container 1. The diameter of the hole 20 is larger than the diameter of the vertical leg 16, so that the vertical leg 16 may rotate in the hole 20 in the direction of curved arrows 21′, 21″. The vertical leg 16 passes through a hole 35 in the bottom 6 and has a cap 14 that is larger than the hole 35 to limit upward motion of the spray pipe 15. A series of nozzles 19, which are best seen in FIG. 4, are formed in the vertical leg 16 for spraying water, paint thinner, solvent, detergent or other cleaning fluid jets 21 into the cylindrical container 1. The nozzles, in their simplest form, may be holes in the spray pipe. Two bars 11 or a single U-shaped member are provided on the top 5. The bars 11 provide a device for holding the paint roller 30 horizontally while permitting the paint roller to move vertically in the container.

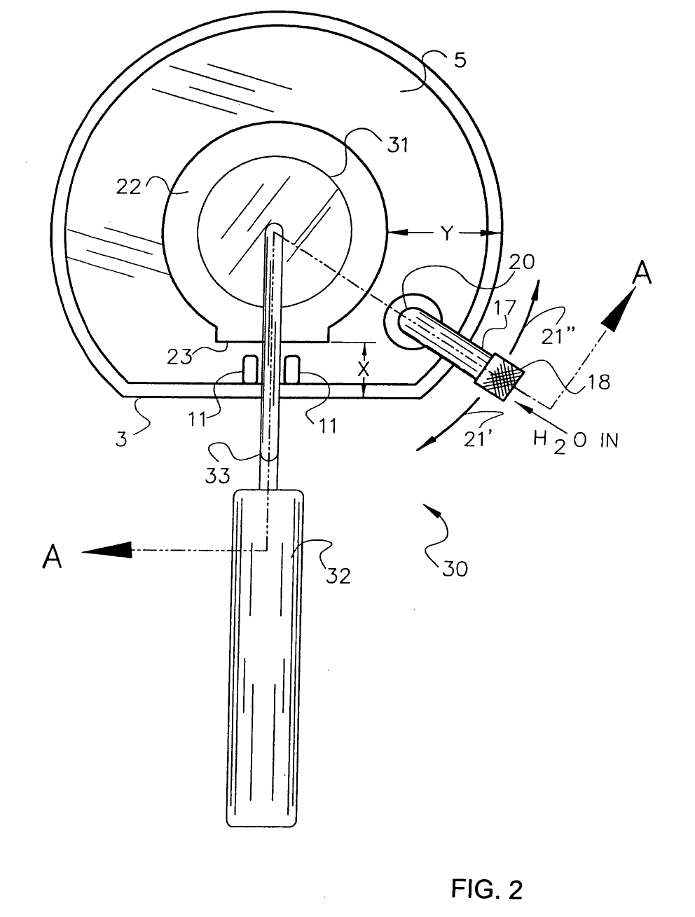

It can be seen in FIG. 2 that the side wall 4 has a flat vertical portion 3 extending to the top 5 and the bottom 6. An insertion opening 22 which is formed in the top 5 has a flat portion 23 which is parallel to the flat vertical portion 3.

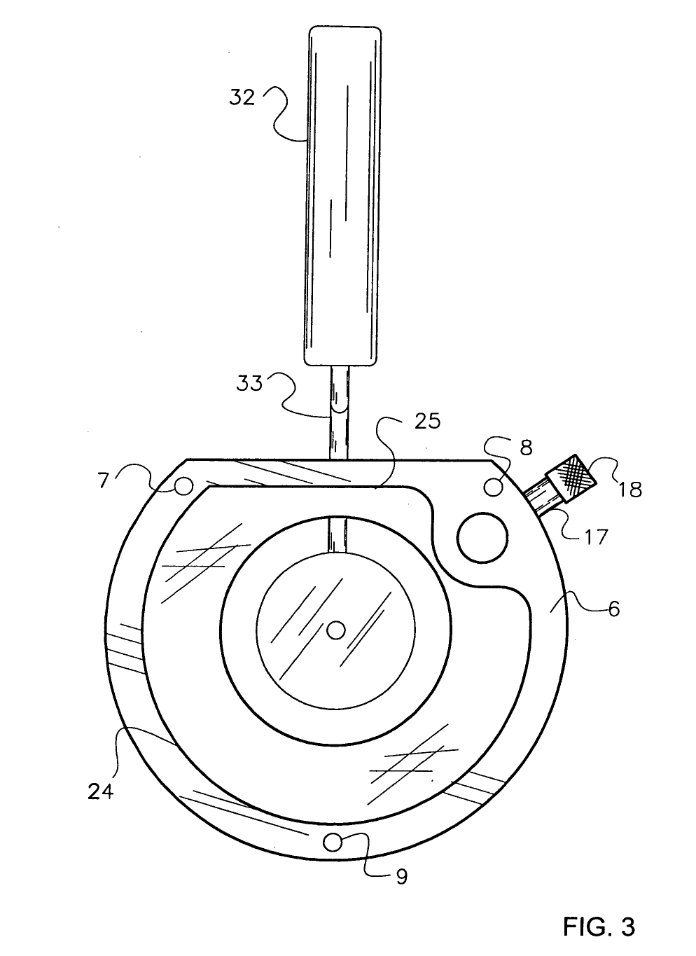

FIG. 3 shows that the legs 7, 8, 9 are spaced equally about the bottom 6, although more legs, for example four, may be used. A discharge opening 24 which is formed in the bottom 6 has a flat portion 25 which is parallel to the flat portions 3, 23. However, little or no bottom is required for the container 1 and if no bottom is used, the legs may be secured to the side wall 4. It is also understood that the openings 22, 24 need not be disposed in the top 5 and the bottom 6, respectively, as long as the insertion opening 22 is above the discharge opening 24.

A paint roller 30 includes a sleeve or tube with a paint-carrying surface 31 having a nap carrying paint, a handle 32 and a bent arm or metal shaft 33 connected between the paint-carrying surface 31 and the handle 32. The sleeve or tube on which the paint-carrying surface 31 is normally disposed may be made of cardboard or plastic and slipped over a support connected to the arm or shaft 33. In order to clean the paint roller 30, the paint-carrying surface 31 thereof is placed through the opening 22 in the top 5 and into the interior of the cylindrical container 1, with the arm 33 loosely disposed between the bars 11. It can be seen that a distance X between the flat portions 3 and 23 in FIG. 2 is less than a given distance Y between the outer surface of the wall 4 and the edge of the opening 22 at other locations. This reduced distance X allows the handle to be loosely disposed outside the cylindrical container 1 with horizontal and vertical play while the paint-carrying surface 31 is loosely disposed in the interior thereof with horizontal and vertical play.

The actual cleaning operation is carried out by introducing water under pressure into the spray pipe 15 through the coupling 18. This causes the water jets 21 to impinge upon the paint-carrying surface 31, as is seen in FIG. 1. When the horizontal leg 17 of the spray pipe 15 is rotated in the direction of the arrows 21′, 21″, the jets wash the paint off the paint-carrying surface 31 and rotate the paint-carrying surface 31. For example, when the horizontal leg 17 is pushed in the direction 21′, the paint-carrying surface 31 will rotate clockwise and when the horizontal leg 17 is pushed in the direction 21″, the paint-carrying surface 31 will rotate counter-clockwise, as seen in FIG. 2. At the same time, the handle 32 is raised and lowered in the direction of the arrows 34 and/or the spray pipe 15 is raised and lowered in the direction of the arrow 36. If the holes 19 are spaced apart by one inch, for instance, then the paint roller 30 is moved up and down by one-and-one-half inches, so that substantially every part of the paint-carrying surface 31 is washed by the jets 21. Due to the large opening 24 in the bottom 6 and the legs 7, 8, 9, the paint which is washed off merely runs out of the cylindrical container 1 onto the surface or basin bottom 10, for proper disposal. When the paint roller is clean, it is removed from the cylindrical container 1.

1. An apparatus for cleaning a paint roller, the apparatus comprising:
a container having:
a continuous side wall,
a permanently-open upper insertion opening for introducing a paint-carrying surface of the paint roller into said container while attached to a handle of the paint roller disposed outside said container, and
a permanently-open lower discharge opening for discharging paint out of said container; and
a device for directing a fluid toward the paint-carrying surface within said container for washing paint off the paint-carrying surface and out of said discharge opening.

2. The apparatus according to claim 1, wherein said container permits vertical movement of the paint roller during washing.

3. The apparatus according to claim 2, which further comprises a device for holding the paint roller horizontally while permitting the paint roller to move vertically in said container.

4. The apparatus according to claim 3, wherein said holding device includes bars disposed on the top of said container.

5. The apparatus according to claim 1, wherein said container has a top, and said upper insertion opening is formed in said top.

6. The apparatus according to claim 5, wherein said container has a bottom end, and said lower discharge opening is formed in said bottom end, said discharge opening being of a size such that said container is substantially bottomless.

7. The apparatus according to claim 1, wherein said device for directing the fluid toward the paint-carrying surface includes a spray pipe.

8. The apparatus according to claim 7, wherein said spray pipe has a coupling for a garden hose and the fluid is water.

9. The apparatus according to claim 8, wherein said spray pipe has nozzles for directing the water toward the paint-carrying surface.

10. The apparatus according to claim 9, wherein said nozzles are holes formed in said spray pipe.

11. The apparatus according to claim 7, wherein said spray pipe is rotatable in said container for directing the fluid toward different locations on the paint-carrying surface.

12. The apparatus according to claim 1, which further comprises legs raising said container and facilitating said discharge of the paint out of said container.

13. The apparatus according to claim 7, wherein said spray pipe is movable vertically in said container over a distance being limited by a stop.

14. The apparatus according to claim 1, wherein said side wall has an outer surface disposed at a given distance from an edge of said insertion opening, and said outer surface has a flat vertical portion disposed at a distance from said edge of said insertion opening being less than said given distance, to facilitate placement of the paint-carrying surface within said container and the handle of the paint roller outside said container.

15. The apparatus according to claim 14, wherein said edge of said insertion opening has a flat portion parallel to said flat vertical portion.

16. The apparatus according to claim 15, wherein said container has a bottom with a flat portion parallel to said flat vertical portion.

17. The apparatus according to claim 1, wherein said device for directing the fluid toward the paint-carrying surface selectively rotates the paint-carrying surface.

18. (canceled)

19. The apparatus according to claim 1, wherein said device for directing the fluid toward the paint-carrying surface is constructed to be rotatable through a range for permitting a direction of rotation of the paint roller to be changed from clockwise to counterclockwise and vice versa by the fluid.
